(19) United States
(12) Patent Application Publication
(10) Pub. No.: US 2025/0218190 A1
(43) Pub. Date: Jul. 3, 2025

(54) POSITION DETERMINATION METHOD OR SYSTEM, FOR DETERMINING THE POSITION OF OBJECTS

(71) Applicants: Captana GmbH, Ettenheim (DE); VusionGroup GmbH, Fernitz-Mellach (AT)

(72) Inventors: Thomas SCHWARZ, Hohberg (DE); Andreas RÖSSL, Fernitz-Mellach (AT)

(73) Assignees: Captana GmbH, Ettenheim (DE); VusionGroup GmbH, Fernitz-Mellach (AT)

(21) Appl. No.: 18/847,490

(22) PCT Filed: Apr. 8, 2022
(86) PCT No.: PCT/EP2022/059508

§ 371 Date: Sep. 16, 2024

(51) Int. Cl. G06V 20/56; G06Q 30/0601; G06T 7/292; G06T 7/50; G06T 7/80; H04N 7/22; H04N 23/56; H04N 23/661; H04N 23/90

(52) U.S. Cl. CPC G06V 20/56; G06Q 30/0639; G06T 7/292; G06T 7/50; G06T 7/80; H04N 7/22; H04N 23/56; H04N 23/661; H04N 23/90; G06T 2207/30244; G06T 2207/30252; G06V 2201/02

(57) ABSTRACT

The invention relates to a method for determining the position of at least one object (P1-P6) in a space (2), in particular of at least one product positioned on a shelf (7), wherein the method includes: emitting a light signal, encoded with identification information for identifying the object, from a light-emitting device (6) positioned adjacent to the object, and capturing a scene with the aid f at least one freely movable camera (10), wherein a digital scene image generated with the aid of the camera represents the scene, and generating object position data on the basis of a computer-determined position of the light signal appearing in the digital scene image in relation to the camera and the identification information emitted with the light signal, and on the basis of an automatically determined orientation and position of the camera in the space when the scene is captured, wherein the object position data represents the position of the object in the scene with respect to the space.

### TECHNICAL FIELD

The invention relates to a method and a system for determining the position of objects, in particular for capturing the position of products.

### BACKGROUND

US2021073489A1 discloses a system for capturing the position of a plurality of products in retail premises. However, the system and also the method disclosed in connection with the system have proved extremely complicated, labour-intensive and costly, because all shelves must be equipped with a special device for identifying a shelf, namely an “identity information provision apparatus.” This special device is generally disclosed as a wireless communication apparatus that can be used either as a separate device or as part of an electronic price display. This device and the information conveyed by it for the identification of a shelf must be compulsorily captured with the method.

The object of the invention is therefore to avoid the problems associated with a system that have been discussed and the method implemented using said system.

### SUMMARY OF THE INVENTION

This object is achieved by a method according to claim 1. The subject matter of the invention is therefore a method for determining the position of at least one object in a space, in particular of at least one product positioned on a shelf, wherein the method comprises emitting a light signal, which is encoded with identification information for identifying the object, from a light-emitting device positioned adjacent to the object, and capturing a scene with the help of at least one freely movable camera, wherein a digital scene image generated with the help of the camera represents the scene, and generating object position data based on a computer-determined position of the light signal appearing in the digital scene image relative to the camera and the identification information emitted with the light signal, and with knowledge of an automatically determined orientation and position of the camera in the space when the scene is captured, wherein the object position data represent the position of the object in the scene relative to the space.

This object is further achieved by a freely movable device according to claim 12. The invention therefore relates to a freely movable device, particularly a shopping trolley, glasses, a mobile phone or a tablet computer, for determining the position of at least one object in a space, particularly of at least one product positioned on a shelf, wherein this position is indicated by a light signal emitted by a light-emitting device positioned adjacent to the object, which encodes identification information with the help of which the object can be identified, wherein the device carries at least one camera designed to generate a digital scene image of a scene captured by it, and wherein the device, particularly the camera, is designed for the computerized determination of the position of the light signal appearing in the digital scene image relative to the camera and the identification information emitted with the light signal, and wherein the device, in particular the camera, is designed at least to support an automated determination of the orientation and position of the camera in the space when the scene is captured.

This object is further achieved by a light-emitting device according to claim 13. The invention therefore relates to a light-emitting device, particularly a shelf label, which is designed to display product and/or price information, or a product separator designed to separate different products, wherein the light-emitting device comprises a memory stage for storing identification information, with the help of which an object, particularly a product positioned on a shelf, in the vicinity of which the light-emitting device is positioned, can be identified, and a light signal generation stage designed to encode a light signal according to the identification information and to emit this encoded light signal.

This object is further achieved by a system according to claim 14. The invention therefore relates to a system for determining the position of at least one object in a space, particularly of at least one product positioned on a shelf, wherein the system comprises at least one light-emitting device according to the invention and at least one freely movable device according to the invention.

The measures according to the invention have the advantage of creating a system that can be implemented and operated more efficiently and cost-effectively, as it requires fewer permanently installed devices on the shelves that need to be separately provided and maintained compared with the system discussed above. This primarily relates to the elimination of the device discussed above that provides information for identifying the shelf on which it is mounted. Furthermore, a substantially more efficient method is created because in this case the full focus is on the emitted light signal, which spatially corresponds to the respective location of an object or product on the shelf and originates there, making it suitable for identifying the object. In addition, the freely movable camera allows a real-time dynamic and spatially variable capture of the positioning of objects present in a retail premises. Therefore, capturing the position of objects in the retail premises is entirely independent of a camera-based capture of the objects themselves or a camera-based capture and evaluation of product-specific information conveyed with the help of the objects or a shelf label, which would need to be found with a large amount of digital processing in a digital image (digital photo or video) of the object or in a digital image of a paper-based shelf label or in a digital image of the screen content of an electronic shelf label.

Further particularly advantageous embodiments and developments of the invention will emerge from the dependent claims and the following description.

In general, the invention allows the position of the object to be determined based on the light signal in the space of a retail premises, thereby locating the object. In order to identify the object, the aforementioned identification information communicated with the help of the light signal is used. This identification information is obtained through a preceding logical association of the object with a light-emitting device assigned to it. Specifically, the logical association involves so-called “binding”. In this case, a unique identification of the object is created with a unique identification of an electronic shelf label (abbreviated to ESL), for example. Typically, the barcode depicted on the object and the barcode displayed on the ESL screen are scanned using a manually operated barcode scanner and stored together in a database. The same also applies to a so-called shelf divider or product divider that separates different objects and products or product groups from one another on a shelf. The barcode uniquely identifying the divider can be depicted on a label on the divider or also displayed on a screen of the divider. Usually, either ESLs or dividers are installed on shelves, wherein mixed configurations are also possible, however. Accordingly, the identification information may be a unique identifier of the ESL or the divider or a unique identifier of the product. Of course, other information, for example meta-information representing the logical association created during binding, can also be used, wherein the product or product group can again be inferred from this meta-information.

The light-emitting device, which emits the light signal, is designed as an ESL or divider in this case. The light-emitting device the stores respective identification information by means of identification data in its memory stage, which is realized, for example, by an EEPROM. The identification data can be transmitted to the respective light-emitting device from a central data processing unit, e.g. wirelessly or in a wired manner. In addition to other electronic components necessary for the respective functionality, the light-emitting device comprises a light signal generation stage, with the help of which the coded light signal can be emitted. For this purpose, the light generated with the help of an LED, for example, is modulated according to the coding to be applied (determined in advance). The intensity or, in the case of an RGB LED, also the colour, i.e. the spectral characteristics of the light, can be influenced in this case. The light signal can be located in the visible spectrum of light. However, the non-visible spectrum is preferably used to avoid unnecessarily distracting customers and staff from their usual activities with light signals. The light signal is emitted for at least the period necessary to send the entire identification information. This emission can occur once or multiple times, particularly following an external request (e.g. by a control signal from a central data processing unit or the camera), or multiple times automatically, such as in a manner controlled by an internal timer of the light-emitting device.

A still camera or a video camera can be used as the camera, which is designed to create a two-dimensional digital image of the scene within its capture area, i.e. a digital scene image. Irrespective of whether it is a still camera or a video camera, at least as many individual scene images, or also a sufficiently long-lasting video as a scene image, is/are captured to allow evaluation of the identification information that appears over a time period. When the minimum duration of the capture period is measured, the time period needed to send the identification information is taken into account. In the case of a light signal in which the identification information is coded over a time period, at least as many images within the time period provided for emission are captured in the case of a still camera, so that the identification information can be easily determined from the changes in the light signal in the scene image.

The real scene captured by the camera comprises the objects or items present in the scene, as well as any potential temporal or spatial changes.

The digital scene image is the optical representation of also the real scene through the optics (a lens system, called an objective) of the camera on the camera's digital image capture unit, for which purpose a so-called CCD is typically used, wherein CCD stands for charge-coupled device and the scene is thereby digitized on it. The scene image is therefore mapped on a pixel matrix of this image capture unit.

The digital scene image is therefore a two-dimensional data structure obtained through the matrix of pixels of the CCD. Depending on the execution of the electronic sensor and the other post-processing camera electronics, a digital still image forming the digital scene image or also a digital video sequence of the scene is generated. The resolution of the electronic image sensor and/or the digital post-processing defines the image resolution (total number of pixels or the number of columns (width) and rows (height) of a raster graphic) of the digital scene image. The digital scene image thereby generated by the camera for further processing is therefore formed by a matrix of pixels, so for example 1500 pixels in the x-direction and 1000 pixels orthogonally thereto in the y-direction. Each of these pixels has a defined (i.e. known) pixel dimension (or in other words, the centre of adjacent pixels has a defined (i.e. known) pixel distance).

In the computerized determination of the identification information, the light signal is first searched for in the digital scene image. This is relatively easy to find because the light signal differs fundamentally from the otherwise rather dark background of the digital scene image. For this purpose, pixels of this digital scene image can be checked for a characteristic colour or a characteristic intensity or brightness, for example. In addition, the temporal colour change or also the change in brightness/intensity to be expected according to the coding of the light signal can be used to search for it. Once a light signal of this kind has been found, the temporal change (modulation) of a light signal parameter is analyzed, with the knowledge of a coding scheme used when the light signal was emitted, in order to decode the identification information from it.

For further processing of the light signal, the position of the light signal that has been found in the digital scene image, i.e. the pixel coordinates, and also a data representation of the identification information determined are stored together.

Capturing the digital scene image with a freely movable camera generates different digital scene images of the real scene or of the camera's surroundings over time, from positions and with different orientations, which can all be evaluated individually or in temporal and spatial context with one another, in order to determine the position of one, but preferably multiple, objects.

In the system, preferably used in a supermarket, a relatively large number of light-emitting devices are typically used according to the large number of different products. In the maximum expansion stage, there will be at least as many light-emitting devices as there are products or product groups in the shop concerned. Determining the position of the products or product groups in a system of this kind is based entirely on determining the positions of the light signals and their identification with the help of the identification information in the digital scene images obtained over time with the help of the movable camera or the camera moving in the retail premises. The light signal that is uniquely identifiable by means of the identification information in the respective digital scene image allows the assignment of a real object which, by definition, is positioned near the light-emitting device in a space. To locate the object in the space (such as in a retail premises, for example), from which one or more digital scene images have been captured with the help of the camera, so in order to obtain the object position data in relation to the space, the position of the respective light signal is first determined in relation to the camera (the camera coordinate system) and then transformed into the coordinate system of the space (the space coordinate system), which has its origin at a defined location in the space and is oriented in a defined manner there.

The various aspects of this generation of the object position data are discussed below.

According to one aspect of the invention, only a single freely movable camera can be used which is carried through the space, such as the retail premises, by an employee, for example. The method is preferably carried out using multiple cameras moved independently of one another. These cameras can be moved independently of one another by the shop staff, which accelerates the capture process when capturing various scene images throughout the entire space.

In order to capture the largest possible area by camera, a so-called fisheye lens can be used for this purpose. Naturally, the lens or the objective itself can also be designed to be movable, i.e. tiltable in relation to the camera. Alternatively, the camera itself can also be tilted in relation to the freely movable device. Alternatively, an omnidirectional camera can also be used.

For the purpose of moving the camera, the staff can be equipped with (protective) glasses, for example, to which the respective camera is attached. However, it has proved particularly advantageous for the freely movable camera to be attached to a shopping trolley. This has the advantage that the number of image-capturing cameras is no longer limited to the number of staff moving around the shop, but rather the individual movements of the customers, who usually far exceed the number of staff, can be used for image capture. In this case, customers move a swarm of image-capturing cameras around the shop premises. Involving customers brings with it another advantage in that the captured images can be used to identify shop zones in which products attract greater customer attention or in which customers actually take products from the shelves, because it is possible to determine based on the captured scenes that these shop zones appear more frequently or because customers spend more time there. This provides valuable insights for inventory management, stocktaking, shelf restocking planning, as well as for target marketing or product-specific marketing.

Regardless of whether the freely movable device is a pair of glasses or the like, or a shopping trolley, it has proved particularly advantageous if multiple cameras are provided on the freely movable device, which cameras are moved with one another, so in a group, with this freely movable device and generate individual digital scene images from different capture positions and/or with different capture orientations. This allows digital scene images of different scenes to be generated at the respective position at which the freely movable device is currently located. For instance, in a supermarket aisle, the shelves on both the left and right sides of the aisle can be simultaneously captured if, for example, one camera is oriented to the left and the other camera to the right in relation to the shopping trolley's direction of travel; in other words, their respective capture areas are directed towards the shelves adjacent to the shopping trolley. The same of course also applies to the aforementioned glasses. To ensure unproblematic, in other words reliable, capture of the full height of shelves, especially with a shopping trolley, multiple individual cameras can be provided on one or each side. These can be arranged above one another on a shopping trolley, e.g. mounted on a pole or also oriented differently to capture an upper shelf area, a middle shelf area and a lower shelf area. Glasses can also have cameras oriented to one of the sides with different capture areas arranged above one another, capturing an entire image area from the lowest shelf to the highest shelf. Optionally, wide-angle cameras can of course also be used to cover the same or a similar overall capture area. The individual capture areas can also overlap.

The ESLs (Electronic Shelf Labels) or dividers that form the light-emitting device are often battery-operated.

Therefore, it has proved particularly advantageous if a control signal transmitter, which moves with the at least one freely movable camera, emits a control signal, particularly a radio-based control signal, and the light-emitting device located within the reception range of the control signal, equipped with a receiver for receiving the control signal, only emits the light signal when it receives the control signal. A relatively simple receiver is necessary for receiving the control signal, which can also evaluate a unique identifier of the control signal to avoid reacting to other radio signals. This confines the light emission by various light-emitting devices to a defined area around the control signal transmitter. For example, a control signal range of five to ten meters may already be sufficient to activate only the light signal generation stages positioned in the vicinity of the at least one camera to emit the respective light signal. The range of the control signal should be of such dimensions that the capture area of the camera is optimally utilized. Therefore, at least those light signal generation stages should be active where the light signal can be reasonably assumed to be capable of capture by the camera. This has the advantage that other light signal generation stages can remain inactive, positively influencing the energy balance of the respective light-emitting device, in particularly also the energy balance of the entire system.

For this purpose, radio technology can be used, for example, in which the control signal emitted is at least partially shielded by the often metal-constructed shelves, so that mainly those light-emitting devices that are in the same aisle as the freely movable device can receive the control signal.

Instead of using the radio-based control signal, or in addition to using the radio-based control signal, the light-emitting device can be designed to emit the light signal only when certain (time-dependent) criteria are met. To apply the criteria, the light-emitting device has a timing control stage designed to control the timing behaviour, i.e. the active or inactive phase(s) of the light signal generation stage. The light signal generation stage is naturally designed to be controllable by the timing control stage and can be controlled by it.

The timing control stage can, for example, receive time data that includes information about the current time and/or have a clock generator, with which the timing control stage determines the current time or date. However, this information can also be obtained in other ways, such as a system clock or system time or system date globally available within the system.

The criteria can include, for example, that the light signal is only emitted if it has not already been emitted within a certain period. The criteria may also include, however, that the light signal emission is only allowed to take place within a specific time range. This time range can include one or multiple predefined fixed time windows during a day, a week, or a month. The system can thereby be set in such a manner, for example, that light signals are only emitted on certain days of the week. The entire retail premises can thereby be scanned once a week, for example, in order to check the consistent positioning of products. The light signal emission can also be assigned to different aisles in the retail premises on different days of the week, so that adjacent aisles do not emit light signals simultaneously. Also with the use of glasses, the criterion can be defined in such a manner, for example, that the light signal is only emitted within the time period during which employees are typically, i.e. predictably, walking through the shop wearing the glasses, preparing it for the next day's operation, for example.

The method has proved particularly advantageous when determination of the position in relation to the camera includes an automatic determination of a scale that can be derived from the digital scene image, wherein the scale is determined based on the known real dimensions of reference object identified in the digital scene image, particularly designed as an electronic shelf label, and the scale is used for converting between position data or dimensions determined in the digital scene image and position data or dimensions in the scene captured with the help of the camera.

For this purpose, a reference object contained in the scene image, preferably identically designed reference objects, can be identified, wherein the actual dimensions are known and the scale for the scene image is determined based on the known actual dimensions.

In the context of the present invention, the reference object is particularly preferably the light-emitting device itself, which is realized as an divider ESL or with typically defined, i.e. previously known, dimensions. These reference objects can be easily found, i.e. located or delineated in the digital scene image due to the inherent light signal they emit, and subsequently analyzed for scale determination. Pattern recognition can be used to identify or locate the reference object in the digital scene image, examining the digital scene image for the characteristic appearance (such as rectangular or square shapes or also proportions) of the reference object. The starting point for searching for the reference object(s) in each case is the light signal they usually emit, making it particularly easy to find in the digital scene image.

The reference object may also be a “composite” reference object formed by a collection of light signals from different light-emitting devices. For example, the light signals from two light-emitting devices positioned substantially directly above one another on different shelves can form a “composite” reference object of this kind, wherein in this situation the distance between the shelves is the known actual dimension used to determine the scale.

As previously mentioned, the present invention has its preferred application in the retail trade. In retail, a reference object of this kind can have various forms. For example, it may be an entire shelf, the length and height of which are precisely known, for example. Using the shelf may therefore be advantageous, because it often plays a dominant role in a scene image. However, smaller objects, such as a shelf strip that forms a front edge of a shelf, can also be used as the reference object. Shopping baskets used to display goods in the shop can also be suitable for this, provided they are positioned within the capture area of the respective camera. However, in the retail trade, shelves or shelf strips, as well as shopping baskets, are often provided by various manufacturers with different dimensions for the respective shops of various retailers, often also under specific structural conditions of the retailers. Therefore, they are only suitable as reference objects in a very narrow application scenario.

Using an electronic shelf label as the reference object is further so advantageous because electronic shelf labels of this kind generally have uniform dimensions. Electronic shelf labels of course exist in a wide variety of entirely differing sizes. In practice, however, it has been shown that the dimensions used vary little or only within a predefined range between different shops or also different retailers. This is particularly true for the plurality of electronic shelf labels installed on a shelf rail or the shelf rails of this shelf in a single shop, which usually come from a single manufacturer. Electronic shelf labels of this kind typically appear in only one to two (perhaps also three) different dimensions on a shelf. Since each of these electronic shelf labels must fit into the same shelf rail, they often differ in their measurements or dimensions only in width, whereas the height is often identical for two different types of electronic shelf labels, for example. However, the reverse scenario can also be true. Their actual dimensions are therefore substantially uniform across different types of electronic shelf labels and installation sites.

Furthermore, the choice of electronic shelf labels as the reference object has proved particularly advantageous for another reason. Unlike the shelves themselves or also the shelf strips, etc., electronic shelf labels are always attached to the foremost front edge of a shelf, making them easily and clearly identifiable in the scene image captured by the camera and therefore reliably analyzable by means of digital image processing.

The basis for scale determination is counting the relevant pixels associated with the reference object. The number of pixels determined in this way can be compared to the real area or length of a reference object, allowing for scaling from the pixel system of the CCD sensor to the real scene. Knowledge of the exact physical parameters of the CCD sensor can also be used in scale determination, consequently the actual distances between the pixels of the pixel matrix or the size thereof are accurately known. Hence, the counted pixels can be converted into an actual length or area measurement for the reference object imaged on the CCD sensor, the current scale calculated from it and then length and area measurements of an image on the CCD sensor can be scaled to the real scene.

Specifically, determining the pixels associated with the image of the reference object in the scene image, i.e. the pixels of the reference object image, can take place using at least one of the methods listed below:
determining the number of pixels occupied by the reference object image in the area. By counting the pixels, the area occupied by the reference object image (surface area given as the sum of the pixels counted or surface area given as the total pixel area of the pixels counted) in the scene image can be determined, and knowing the actual area of the reference object (e.g. the surface area of the front face of the reference object in square millimetres), the scale can be calculated;
determining the number of pixels occupied by the perimeter of the reference object image or the number of pixels enclosing the perimeter of the reference object image. The perimeter of the reference object image in the scene image is determined by counting the pixels, either based on the edge pixels just occupied by the reference object image or based on the pixels immediately adjacent to the reference object image. Knowing the actual perimeter of the reference object (e.g. the perimeter of the front face of the reference object) allows the scale to be calculated;
determining the number of pixels occupied by the reference object image along one of the boundary lines or the number of pixels enclosing the reference object image adjacent to one of its boundary lines. The length of an edge line is therefore used as the basis for scale determination. This may, in particular, be a straight edge line, such as a side of a rectangular or square structure of the reference object, which may be given by housing edges, for example. Therefore, either the pixels that lie along a boundary line of this kind are counted or the pixels that are adjacent to one of the boundary lines enclosing the reference object image are counted. Knowing the actual length of the boundary line of the reference object allows the scale to be calculated.

With the measures described, however, a scale can also be defined that scales along the scene image, therefore defining a scale that depends on the location in the scene image. This location-dependent scale can be necessary if, for example, the scene image distorts the proportions of the reference objects depicted there. A situation of this kind can occur, for instance, when using the camera to capture a scene extending far to the left or right of the camera, which can occur in the aisles of retail premises when there is an unfavourable camera orientation. Reference objects located in the vicinity of the camera are then depicted as larger than objects positioned further away from the camera.

In connection with perspective images of this kind, it could also be possible to derive the profile of the scale along the scene image from the distortion of a single reference object. However, if the length of this reference object along the perspective to be evaluated is relatively short and, unfavourably, there are also only a few pixels assigned to the reference object, this can often only lead to a suboptimal result.

Therefore, it is preferable to use multiple reference objects of this kind which are ideally distributed fairly evenly along the perspective image, which is often the case with ESLs, so that the function describing the location-dependent scale can be defined as accurately as possible. A scale of this kind is also referred to as a metric.

Based on the totality of the light signals recognized in the digital scene image, a first data structure can be generated using the scale for the scene image, representing a two-dimensional digital map of the light signals in the real scene, indicating the actual measurement(s) necessary for the two-dimensional cartography (e.g. measured in millimetres). For this purpose, only linked measurements (i.e. relative measurements between adjacent light signals) can be created, in order to determine the positions of the light signals. Absolute measurements taken from a reference point in the scene image can also be created. This two-dimensional map obtained in this way which is digitally stored is subsequently used to set it in a three-dimensional context in relation to the camera; this will be discussed later.

According to this aspect, determining the position in relation to the camera includes automatically determining the distance between the camera and the scene captured by it. This allows the light signals identified in the digital scene image to be located three-dimensionally in relation to the camera, i.e. in the camera coordinate system. Hence, the two-dimensional location of the light signals already known in the scene is extended by a third coordinate.

The distance can be estimated in a substantially known spatial arrangement, such as an aisle, for example, so using about half the aisle width. This distance can also be well defined using the so-called lens equation, because the scale or metric can be accurately defined with the help of the reference object found in the digital scene image, the dimensions of which are very accurately known. The distance between the camera and the respective light-emitting device can therefore be automatically calculated, knowing the parameters of the camera's optical imaging system. This can be done fully automatically by the camera's computer, because it can retrieve the parameters of the optical imaging system from its memory, where they were pre-programmed (e.g. during the camera's manufacture or commissioning), and because the computer knows the actual dimensions of the reference object, which is also available, as they were pre-programmed, for example. Hence, using the generally known lens equation, for example, the distance of the camera from the real object from which the light signal is emitted, so ultimately the distance to the light signal source, can be calculated in the scene, wherein in this case the imaging function corresponding to the actual lens of the camera must be used. Consequently, the positions of the light signals can be determined in the spatial context of the camera coordinate system. It should also be noted here that the distance between the camera and the light-emitting device can also be determined by automatic determination by means of a distance sensor, wherein a LIDAR sensor or similar, for example, can be used for this purpose. This enables precise direct distance measurements, wherein the camera's computer processes the data transmitted by the LIDAR sensor, in order to obtain the third coordinate in the spatial context of the camera coordinate system. In addition, so-called “Time of Flight” sensors can also be used to automate this distance measurement.

Since this camera coordinate system changes its position and orientation according to the camera movement in space, while at the same time the position of the light-emitting device in space remains unchanged, the three-dimensional coordinates calculated in the camera coordinate system for a particular light-emitting device exhibit variability or dynamics dictated by the movement of the camera.

According to another aspect, it has proved advantageous for the method step of emitting the light signal to be carried out substantially simultaneously by multiple light-emitting devices, and wherein the method step of computerized determination of the position of the light signal appearing in the digital scene image in relation to the camera and the identification information emitted with the light signal is carried out for the totality of the light signals appearing in the digital scene image. This has the advantage that the plurality of light signals contained in a scene image is used collectively to perform the position determination for the plurality of light signals in a single capture by the camera. This speeds up and optimizes the position determination process.

Once the three-dimensional position data of the light signals are obtained in the camera coordinate system, these data are transformed into the spatial coordinate system of the space, so that the object position data is thereby obtained, since each light signal identifies an object that is adjacent to the location where the light signal is emitted. In this case, according to another aspect of the method for generating the object position data, supplementary data are taken into account, which include at least one of the following types of data:
orientation data which describe the orientation of the camera in relation to a reference orientation in the space;
inclination data which describe the tilt of the camera in relation to a reference plane in the space;
position data which describe the position of the camera in relation to a reference point in the space.

These supplementary data can be generated with the help of various sensors that exist on the camera or the freely movable device, such as the shopping trolley or the glasses, for example, as will be discussed further below.

The orientation of the camera in the spatial coordinate system can take place automatically by means of an orientation sensor, wherein an electronic compass can be used for this purpose, for example, with the camera's computer processing the data transmitted by the electronic compass and providing these data for the conversion between the coordinate systems. In addition, the tilt of the camera, represented by the inclination data relative to the horizontal plane, can be part of the orientation. This can be detected through an automatic determination by means of an inclination sensor, wherein an electronic gyroscope is used for this purpose, for example, with the camera's computer processing the data transmitted by the electronic gyroscope and providing these data for conversion between the coordinate systems.

The position of the camera in the spatial coordinate system can be determined automatically using radio-based positioning, particularly with the help of Ultra-Wideband radio technology (abbreviated to UWB radio technology), wherein for this purpose UWB transmitters installed in a fixed manner (at various points in the relevant spatial area) with a known position in the spatial coordinate system are used and the camera is provided with a UWB radio module, with the help of which the position of the camera in relation to the UWB transmitter is determined in the case of the respective UWB transmitters that are in UWB radio communication with the camera, from which position data are generated which are processed by the camera's computer and provide for the conversion between the coordinate systems. Since the camera used is preferably miniaturized, the position of the camera in the spatial coordinate system determined in this manner be can approximately equated with the origin of the camera coordinate system. Otherwise, an adjustment taking the difference into account would need to be implemented.

The path covered can also be recorded by means of a sensor (e.g. attached to the casters of a shopping trolley to detect the rolling movement of the casters or wheels) or a sensor to detect accelerations, from which the distance covered and direction taken can be determined, and data describing the path covered, which the camera's computer processes and provides for the conversion between the coordinate systems, are generated. However, a known starting point in the spatial is coordinate system necessary for this purpose, in order to be able to describe the path.

Hence, with the help of the supplementary data, which describe different characteristics depending on the system configuration, the conversion into the spatial coordinate system can be carried out directly in the camera, on the one hand, and the object position data of the real scene in the spatial coordinate system thereby obtained are transmitted by the camera for further processing by a central data processing unit, for example. On the other hand, the camera can also transmit the position data of the light signals in the spatial context of the camera coordinate system, along with the supplementary data present at the camera, and a central data processing unit, for example, can perform the conversion into the spatial coordinate system.

Consequently, in the spatial coordinate system, the three-dimensional positions the individual light-emitting devices and the identification information they convey are now known. Using the identification information, the objects that are actually affected are queried for the respective position from a database of the (central) data processing unit, for example, and the (central) data processing unit subsequently generates a data structure for the entirety of the objects from the object position data determined for each object, which data structure contains the three-dimensional position of each object in the shop in the spatial coordinate system. This is also referred to in the technical jargon as a three-dimensional floor plan of a shop, which represents as accurately as possible the position of all products in the shop.

In the present case, this floor plan, as discussed, is not generated manually, but fully automatically based on the light signals from the electronic shelf labels or dividers installed in the shop and with the help of freely movable cameras that capture the light signals during their movement in the shop over the course of time.

It may also be provided that sequences of scene images are used together to determine the position of objects. These sequences may also involve overlapping the capture areas. This allows positions for one and the same light-emitting device to be determined in successive scene images, for example, and for the scene images thereby to be linked to one another by overlaying the positions of the light signals in the various scene images. This coupling of the scene images leads to an extension of the capture area of the one camera or multiple cameras used.

Data that have already been generated which locate light signals and specify their identification information can be used in this case to interpret newly generated scene images. By utilizing image position data that have already been generated, i.e. the position and identification of the light-emitting device that has already been captured, newly generated scene images containing the same light-emitting device can be easily interpreted. Light-emitting devices that have not yet been captured can easily be described relative to the position of the light-emitting device known. Therefore, dynamic light signal detection is also possible, in which the depicted light signals move in a temporal sequence of scene images. The positions of light signals newly appearing in the sequence of scene images are described based on the positions of light signals already known. The coupling therefore allows for a dynamic, yet secure and reliable, capture and description of the scene.

Consequently, for example, all light-emitting devices installed along an aisle can easily be captured, even if the camera being used could not capture a complete image of the aisle due to its capture area or also its positioning or orientation in relation to the shelf. This measure means that a complete digital scene image of the light-emitting devices installed along the aisle can be generated.

It should also be mentioned that multiple fixed coordinate systems can be used to describe the object position data. So, for example, a local fixed coordinate system can be defined in each aisle, so that the object position data are described in this coordinate system in each case. The dimensions and/or positions, etc. described in the individual coordinate systems can then be easily transformed into one another, knowing the relationship between the coordinate systems. Hence, the object position data can be transformed from the local fixed coordinate systems into the fixed spatial coordinate system encompassing or describing the entire shop.

It should also be mentioned that the freely movable device, in addition to the components already discussed, can also have a battery or accumulator to supply power to the electronic components. The freely movable device can also have a generator to convert kinetic energy into electrical energy. The electrical power provided by the generator can be used directly to power the electronic components or temporarily stored in the battery or accumulator. This generator is preferably connected to, or integrated with, at least one wheel of the shopping trolley when using a shopping trolley as the freely movable device, so that the rotational movement of the wheel drives the generator. The camera can therefore also be operated autonomously on the freely movable device. Equipped with its own power source, the shopping trolley can also power its own drive, in order to assist customers with self-driving functionality. In this context, it can also be provided that the power source is charged wirelessly, e.g. at the usual collection points for shopping trolleys of this kind.

It should also be mentioned that when a shopping trolley is used, it can be equipped with a screen, particularly a touch screen, and an associated data processing unit, allowing the customer to interact the with shopping trolley. So, for example, a digital shopping basket can be displayed on the screen, showing which items have been placed in the trolley. The customer's shopping list can also be displayed. Detailed information about products can also be provided in this way. For this purpose, the shopping trolley can be equipped with a barcode scanner or an NFC communication module, allowing products placed in the shopping trolley to be scanned or detected. The shopping trolley can also have an additional camera or use the previously discussed camera to capture products that are placed in the trolley. For this purpose, the camera captures the product placed in the cart and creates a product image. In this case, the products can be identified using a barcode, QR code or similar, for example. However, the object position data available substantially in real time also allow for product identification based on the structure thereof in the product image. By using the currently generated object position data, the product image can be compared with a reduced selection of possible products, relative to the total range, which products are located in the scene or the vicinity according to the object position data. Consequently, the object position data allow for faster and more reliable processing of the product image and recognition of the products located therein. A shopping trolley of this kind may also be equipped with a scale designed to weigh products placed in the trolley. The data generated from this can be used, for example, to determine a weight-dependent price. The contents of the shopping trolley captured in this way can also be used at the same time for a reliable self-checkout process, including the payment of all items, particularly also those dependent on weight. For this purpose, an NFC payment terminal can be provided on the shopping trolley, allowing a payment to be processed using the NFC functionality of a mobile phone, for example. So that items not equipped with an NFC chip can also be captured, a barcode scanner can be provided in the shopping trolley, allowing the self-checkout process to be carried out in any case.

The shopping trolley may also have an NFC communication module for detecting items on the shelves, allowing NFC tags, for example, that are attached to items to be detected as the shopping trolley passes by. In this configuration, the shopping trolley can be used not only to determine the position of the items, but also to simultaneously record the number of items actually present at the respective (shelf) location. This allows the inventory in the shop to be continuously monitored in practice by the swarm of shopping trolleys moving around the shop and the recorded inventory data to be transmitted from the shopping trolley to the server via a radio communication module, where they are integrated into the floor plan and also visualized there.

As the shopping trolley moves, the customer can also be provided with location-specific marketing information via the screen, because the server 8 is always informed of the location of the shopping trolley with the help of the supplementary data.

Furthermore, the server 8 can conduct a customer behaviour analysis, because the server 8 has real-time access to the movement patterns of the shopping trolley, possibly even with data that represent or indicate the contents of the shopping trolley.

The shopping trolley may also have a visual signal output device (e.g. an LED or the screen) to indicate whether the shopping trolley is already occupied or also if the user of the shopping trolley requires assistance from the shop staff.

The shopping trolley may also have a cost-effective LIDAR system which can be used to capture the customer's attention in an environmentally specific manner, e.g. by providing environmentally specific information on the screen.

Finally, it should also be generally mentioned that the electronic devices or equipment discussed naturally have electronics. The electronics can be built using discrete components, integrated electronics or a combination of the two. Microcomputers, micro-controllers, application-specific integrated circuits (ASICs), possibly in combination with analog or digital electronic peripheral components, can also be used. Many of the mentioned functionalities of the devices are realized with the help of software executed on a processor of the electronics, possibly in conjunction with hardware components. Devices designed for radio communication typically include an antenna configuration as part of a transceiver module for sending and receiving radio signals, as well as a modulator and/or demodulator. The electronic devices may also have an internal electrical power supply, which can be realized with a replaceable or rechargeable battery, for example. The devices can also be powered through wiring, either via an external power supply or also by means of “Power over LAN.” A radio-based power supply by means of “Power over WiFi” can also be provided.

These and other aspects of the invention are evident from the figures discussed below.

### BRIEF DESCRIPTION OF THE FIGURES

The invention is again explained in greater detail below with reference to the accompanying figures based on exemplary embodiments, to which the invention is not however limited. In the various figures, identical components are labelled with identical reference signs. The drawings show schematically:

FIG. 1 shows a fundamental setup of a system for carrying out a method according to the invention;

FIG. 2 shows the occurrence of identification information in different light signals over time;

FIG. 3 shows an application of the system in an aisle of a shop.

### DESCRIPTION OF THE EXEMPLARY EMBODIMENTS

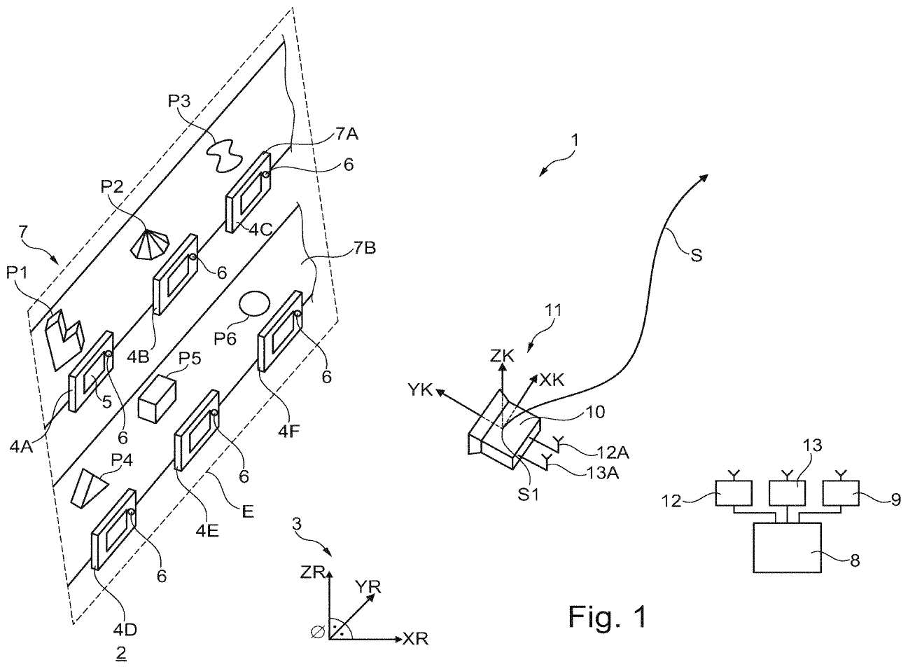

FIG. 1 shows a system (1) for performing a method for determining the position of objects, specifically products P1 to P6, in a shop, hereinafter referred to in short as space 2. In the space 2, a fixed, orthogonal, right-handed spatial coordinate system 3 with its coordinate axes XR, YR and ZR is illustrated, so that the three-dimensional positions of products P1 to P6 can be indicated in this spatial coordinate system 3. A digital representation of these three-dimensional positions is hereinafter referred to as object position data for the respective product P1-P6.

In the space 2, only two shelves 7A and 7B of a shelf 7 are visible, to the front edge of each shelf are attached three electronic shelf labels 4A-4C and 4D-4F respectively, corresponding to or adjacent to products P1-P6, with which they are logically linked and for which they each display product and/or price information on their screens 5. Each shelf label 4A-4F also has a light-emitting diode 6 located on the front next to the screen 5, which is designed to emit a light signal, wherein when the light signal is emitted, it is encoded according to individual identification information and the identification information serves to uniquely identify the respective product P1-P6. In the present case, a binary code forming the identification information is transmitted, wherein the current through the light-emitting diode is either switched on or off according to the value of each bit. This transmission can also be embedded in defined start and stop bits, etc.

The system 1 also includes a server 8 that stores the logical connection between each product P1-P6 and its associated shelf label 4A-4F. The shelf labels 4A-4F receive their product and/or price information to be displayed in each case from the server 8, wherein said information is transmitted with the help of a wireless shelf label access point 9 to the respective shelf label 4A-4F. Since the server 8 therefore knows the identity of each shelf label 4A-4F and the product P1-P6 assigned to the respective shelf label 4A-4F, it is fundamentally sufficient for the light signal only emit to the identification information of the respective shelf label 4A-4F as identification information, so that the server 8 can uniquely identify the product P1-P6 concerned in each case, based on the identification information.

The system 1 also includes a camera 10 that is freely movable within the space 2, so that it can be moved in principle into all areas of the space 2, in order to capture the current scene in each case with the help of a digital scene image. The scene captured with the help of the camera 10 can be described using a camera coordinate system 11 in three-dimensional coordinates XK, YK, ZK, wherein the camera coordinate system 11 is located at the centre of the image-capturing pixels of the CCD sensor of the camera 10, i.e. it has its origin there, and wherein the plane spanned by the coordinates XK and ZK lies in the image capturing plane of the CCD sensor and has a granularity according to the pixels of the CCD sensor. In the pixel matrix of the CCD sensor, each pixel can be specified by a two-dimensional pixel coordinate system with the axes XKP and ZKP, wherein the XKP axis corresponds to the XK axis and the ZKP axis corresponds to the ZK axis in orientation. For simplicity's sake, it is assumed in this case that the pixels of the digital scene image, i.e. the result of the scene image digitization performed with the help of the CCD sensor, are addressable according to the two-dimensional pixel coordinate system.

It is furthermore noted that the third coordinate YK of the camera coordinate system 11 points towards the scene to be captured through an optic (or lens—not shown) of the camera 10. The lens substantially defines a capture area E of the camera. If a digital zoom is available, this capture area may of course also depend on the setting of the digital zoom.

The spatial orientation and positioning of the camera coordinate system 11 in space 2, i.e. in the spatial coordinate system 3, consequently depend on the respective position, and also the orientation of the camera 10 in the space 2.

In the present case, it is assumed that the base area (the floor) of the space 2 coincides with the plane, which is spanned by the coordinate axes XR and YR. For simplicity's sake, the camera is also oriented parallel to the base area in respect of its inclination, meaning that the plane spanned by the coordinate axes XK and YK of the camera coordinate system 11 runs parallel to the base area. It is therefore aligned without an inclination. If the inclination were to be considered, an inclination sensor on the camera 10 would generate inclination data representing the detected inclination.

In the present case, it is further assumed that a reference orientation in space 2 is given by the direction of the coordinate axis XR of the spatial coordinate system 3. The current orientation of the camera 10 is therefore specified in respect of this direction. This can be done with the help of an electronic compass in the camera 10, which is set or programmed to this direction as the reference orientation. An electronic magnetic compass can also be used, wherein the orientation determined with its help in respect of the north direction can be converted in relation to the reference orientation. Regardless of the way of determining the current orientation, the orientation data thereby obtained are provided by the camera 10 for further processing.

The system 1 also includes a radio camera access point 12 connected to the server 8, which transmits the orientation data from the camera 10 to the server 8. For this purpose, the camera 10 has a corresponding camera data radio communication stage 12A (not shown in detail), of which only a first antenna configuration is shown. The camera data radio communication stage 12A is used to transmit the orientation data and, where applicable, also to transmit the inclination data, if said data are to be considered, as well as other image processing data which are to be transmitted as the result of image processing with the help of a computer in the camera 10, hereinafter referred to as the camera computer (not shown).

The position of the camera 10 in the space 2 is determined in the present case with the help of UWB (Ultra-Wideband) radio and this position is approximately assigned to the origin of the camera coordinate system 11. For this purpose, a UWB radio system 13 is provided, the position of which is clearly defined in the space 2 and which is coupled to the server 8, in order to transmit the camera position data determined by means of UWB radio, which indicate the position of the camera 10 in the space 2 (specifically relative to the position of the UWB radio system 13, which can in turn be converted to the spatial coordinate system 3), to the server 8. Of course, the origin of the spatial coordinate system 3 can also be located at the position of the UWB radio system, in order to avoid the conversion that has been discussed. The camera 10 has an appropriate camera UWB radio communication stage 13A (not shown in detail) for the purpose of UWB radio communication, of which only a second antenna configuration is shown.

The method implemented with the help of the system 1 is described in detail below. It is assumed in this case that the camera 10 is currently at location S1 along its path S and is oriented there with its capture area E towards the shelf 7, taking a series of still images, hereinafter referred to as a still image series, of the scene existing within the capture area E. Each still image forms a digital scene image, whose pixels, as discussed, are substantially predefined by the pixel matrix of the CCD sensor of the camera 10.

In the still image series represented by image data, the encoded light signal of each shelf label 4A-4F is now contained at the respective pixel coordinates XKP and ZKP alongside the shelf labels 4A-4F.

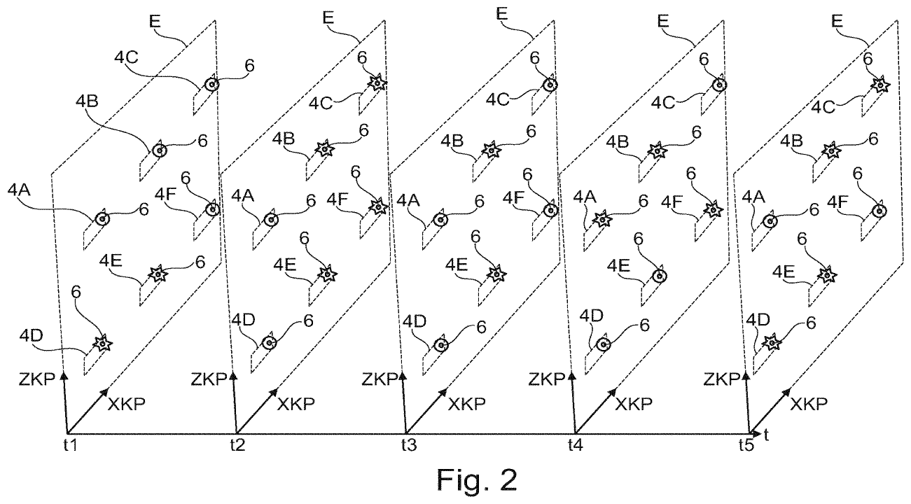

Reduced to the shelf labels 4A-4F and the respective light signal, FIG. 2 now visualizes the image of the scene on the plane of the pixel matrix of the CCD sensor of the camera 10 and shows at five different points in time t1 to t5 the brightness present at the image location for the respective light signal, indicated by the symbols “circle” and “star”. In this representation, a “circle” symbolizes darkness, meaning that the light-emitting diode 6 emitting the respective encoded light signal is currently off. Furthermore, in contrast to the “circle”, a “star” symbolizes brightness in this representation, meaning that the light-emitting diode 6 emitting the respective encoded light signal is currently on.

With the help of the camera computer, it is now determined, on the one hand, by recognizing the encoding of the respective light signal that it is a light signal to be taken into account in the present context and there are no other light signals present that are unrelated to the purpose of the invention, and the position in the pixel matrix for this kind of light signal that is to be taken into account is determined the and respective identification information identified. These determination data at the pixel level are temporarily stored. At this point in time, the identification information determined can already be used to identify the associated product P1-P6.

In a further method step, it is determined how far apart the light signals are in the real scene. For this purpose, a scale is determined, which results from the knowledge of the real dimensions (e.g. edge length of the front frame) of the shelf labels 4A-4F present in the digital image. The positions of the respective shelf labels 4A-4F can easily be determined in the digital scene image with computer assistance, as the light signal is within the visible front or front frame of the respective shelf label 4A-4F. The camera computer also knows the real dimensions (i.e. the actual length of the sections of the front frame) of these shelf labels 4A-4F used as reference objects.

Through pattern recognition, the respective front frame is determined in the digital image, and the number of associated pixels is determined along this frame (along the longer and/or shorter side). Since the physical pixel distances of the CCD sensor are known, the scale can now be calculated to convert the counted pixels (i.e. distances or lengths in the pixel system of the digital scene image) into real length units (e.g. millimetres) in the scene. This makes it possible to determine the relative distances of the light signals in the real scene in respect of one another, in other words to indicate them in the XK-ZK plane of the camera coordinate system 11. Therefore, the positions of the shelf labels 4A-4F and subsequently the positions of the associated products P1-P6 in this XK-ZK plane are also fundamentally defined.

In another method step, the distance from the camera 10 to the scene is determined, in order to supplement the two-dimensional positioning in the camera coordinate system 11 with the third dimension. Since the physical parameters of both the CCD sensor and the lens are known, i.e. the length of an object imaged on the CCD sensor in millimetres, for example, can be determined on the CCD sensor, and the dimensions are also known for the respective reference object in the real scene, this distance between the camera and the real scene can easily be calculated with the help of the camera 10 that stores computer the necessary information by applying the lens equation, so that the position of the light signals in the camera coordinate system 11 can be specified along the coordinates XK, YK and ZK in metric units, for example, (e.g. millimetres).

Subsequently, the object position data determined in the camera coordinate system 11 (which are still in the coordinate notation XK, YK and ZK in this case) for each light signal (and therefore of course also for each shelf label 4A-4F in the broader sense) are transmitted along with the respective identification information from the camera 10 to the server 8. The orientation data determined at location S1 are therefore also transmitted to the server 8. The server 8 also has the camera position data determined for location S1 at the point in time of the image series capture by means of UWB radio communication. The orientation data and camera position data together form supplementary data, with the help of which the position data of the light signals valid for the camera coordinate system 11 are converted in the spatial coordinate system 3 (coordinate transformation, taking into account the fact that the position of the UWB radio system 13 does not coincide with the origin of the spatial coordinate system 3) at the server (8). Thereafter, the object position data define the respective position of the light signals in the coordinate notation XR, YR, and ZR.

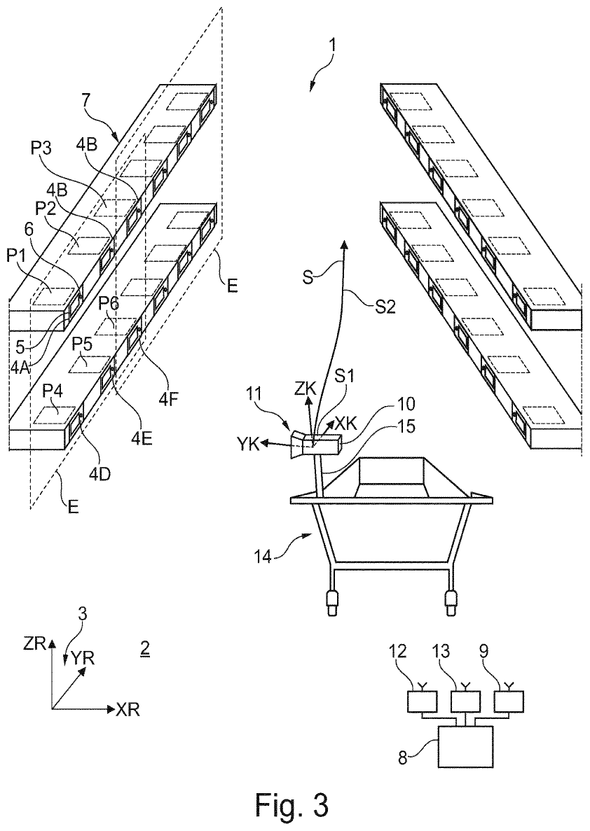

As seen in FIG. 2, the camera 10 can be fundamentally freely movable. Depending on the implementation, it can therefore be mounted on glasses, for example, or on a shopping trolley 14, as shown with the help of FIG. 3.

Specifically, FIG. 3 shows an aisle flanked on both sides by shelves 7, with the shopping trolley 14 carrying the camera 10 on an upright pole 15 moving along the path S. For reasons of clarity, only the first six shelf labels 4A-4F and the first six products P1-P6 have also been provided with reference signs, wherein the products P1-P6 are merely indicated by dashed boxes representing the position of the products P1-P6 on the shelf 7. In the present case, it is assumed that the camera 10 is oriented to the left side of the trolley 14, so that the left shelf 7 lies within the capture area E of the camera 10, wherein the length of the shelf 7 exceeds the width of the capture area E. Along the path S, the camera 10 therefore captures the scene located within its capture area E multiple times, e.g. once at a position S1 and a second time at a position S2. The still image series generated at each location S1 and S2 is processed by the camera computer 10 similarly to the previously discussions and then transmitted to the server 8, which completes the localization of the light signals, and therefore ultimately the products, in the spatial coordinate system with the help of the conversion. If, as can be seen in the present example, the series of images captured from adjacent positions P1 and P2 overlap shelf areas, this can be used to improve the results of determining the object position data because they are generated multiple times for one and the same light signal in the overlap area. The same also applies, moreover, to multiple captures at entirely different times using one and the same camera 10 or using different cameras 10 mounted on different shopping trolleys 14. Moreover, in larger shops the plurality of moving shopping trolleys 14 ensures that the entire shop is mapped with the help of the customers, so the object position data for the totality of products are captured over time.

In order to capture the right shelf 7 shown in FIG. 3, the shopping trolley 14 would need to be turned around and moved along the aisle again or it would need to have two cameras 10, with one camera 10 oriented to the left and a second camera 10 oriented to the right.

The totality of the individual object position data in the spatial coordinate system 3 for the respective products P1, P2, etc., which are gradually collected by the server 8, is ultimately used by the server 8 to create a digital three-dimensional map of the product positions, also referred to in the jargon as a floor plan. The creation or also an update of this three-dimensional map of the products P1, P2, etc., may occur either after a specific capture period has elapsed or successively, in other words as new object position data become available.

Alternatively, it should also be mentioned that the freely movable device (i.e. glasses or shopping trolley) may have a computer that receives raw data from the camera 10 and processes this raw data as described in connection with the camera 10. In this case, the freely movable device may also have the camera data radio communication stage 12A and the camera UWB radio communication stage 13A.

According to another exemplary embodiment, a mobile phone or tablet computer can also be used as a freely movable device carrying the camera. Modern devices of this type are usually already equipped with an excellent camera system, including a sensor (often realized as a flight-of-time sensor) for detecting the distance between the camera and an object captured using the camera. They also have powerful computers capable of easily performing the previously discussed calculations (particularly in real-time) with suitable programming. Devices of this kind involve the use of an app, i.e. software that provides the functionalities discussed in the context of this invention when executed on the device's computer. The positioning of these devices in the space of the shop or warehouse can also be easily determined using the radio equipment integrated in the respective device (such as, for example, WLAN or Bluetooth®), e.g. easily by means of triangulation or using UWB radio, insofar as this functionality is implemented in the respective device. Insofar as devices of this kind do not come factory-fitted with integrated UWB radio, they can be retrofitted with UWB radio devices that can be plugged in at the device's USB port, for example, (e.g. in the form of a UWB radio dongle or a USB-compatible UWB radio device). In the context of this invention, devices of this kind are mainly used by the shop or warehouse staff, wherein they are held towards the shelves and moved past or along them to capture the respective scene. The use of devices of this kind has proved particularly advantageous, because they have an integrated screen that means that staff can always immediately follow and evaluate the captured scene visually on-site and adjust the orientation or alignment where necessary, possibly also the zoom setting or also the exposure, etc. to ensure optimized capture in a single work pass. If no visual just-in-time inspection by staff is required, automatic image or video analysis (e.g. at the server) can also detect areas in the shop or warehouse in which a re-capture of the scene appears necessary, in order to obtain a complete picture of the situation existing there. However, since the devices themselves also have powerful computers, it is also immediately possible to automatically check during capture with the help of the respective device whether the digital scene image is suitable for further processing or whether the scene needs to be re-captured. This can be communicated to the staff, e.g. acoustically by means of the audio module integrated into the device, for example, through spoken instructions from the device or in the form of a dialogue, in such a manner that the staff receive clear instructions, such as to hold the device higher or lower or to change the tilt or orientation in a specified direction, etc.

In conclusion, it is once again pointed out that the figures described in detail above are only exemplary embodiments that can be modified in a whole host of ways by a person skilled in the art without departing from the scope of the invention. For the sake of completeness, it is also noted that the use of the indefinite articles “a” or “an” does not exclude the possibility that the respective features may also be present multiple times.

1. A method for determining the position of at least one object (P1-P6) in the space (2), in particular of at least one product (P1-P6) positioned on a shelf (7), wherein the method comprises:
emitting a light signal, which is encoded with identification information for identifying the object (P1-P6), from a light-emitting device (4A-4F) positioned adjacent to the object (P1-P6),
and
capturing a scene with the help of at least one freely movable camera (10), wherein a digital scene image generated with the help of the camera (10) represents the scene, and
generating object position data based on a computer-determined position of the light signal appearing in the digital scene image relative to the camera (10) and the identification information emitted with the light signal, and with knowledge of an automatically determined orientation and position of the camera (10) in the space (2) when the scene is captured,
wherein the object position data represent the position of the object (P1-P6) in the scene relative to the space (2).

2. The method according to claim 1, wherein the method is preferably carried out using multiple cameras (10) moved independently of one another.

3. The method according to claim 1, wherein the at least one freely movable camera (10) is attached to a shopping trolley (14) or to glasses.

4. The method according to claim 3, wherein multiple cameras (10) are provided which are moved with one another, so in a group, and individual digital scene images are generated from different capture positions and/or with different capture orientations.

5. The method according to claim 1, wherein a control signal transmitter, which moves with the at least one freely movable camera (10), emits a control signal, particularly a radio-based control signal, and the light-emitting device (4A-4F) located within the reception range of the control signal, equipped with a receiver for receiving the control signal, only emits the light signal when it receives the control signal.

6. The method according to claim 1, wherein determination of the position in relation to the camera (10) includes an automatic determination of a scale that can be derived from the digital scene image, wherein the scale is determined based on the known real dimensions of a reference object (4A-4F) identified in the digital scene image, particularly designed as an electronic shelf label (4A-4F), and the scale is used for converting between position data or dimensions determined in the digital scene image and position data or dimensions in the scene captured with the help of the camera (10).

7. The method according to claim 1, wherein determining the position in relation to the camera (10) includes automatically determining the distance between the camera (10) and the scene captured by it.

8. The method according to claim 1, wherein determining the identification information involves analyzing the temporal change in a light signal parameter, with the knowledge of a coding scheme used when the light signal was emitted.

9. The method according to claim 1, wherein the method step of emitting the light signal is carried out substantially simultaneously by multiple light-emitting devices (4A-4F), and wherein the method step of computerized determination of the position of the light signal appearing in the digital scene image in relation to the camera (10) and the identification information emitted with the light signal is carried out for the totality of the light signals appearing in the digital scene image.

10. The method according to claim 1, wherein for generating the object position data, supplementary data are taken into account, which include at least one of the following types of data:
orientation data which describe the orientation of the camera (10) in relation to a reference orientation in the space (2);
inclination data which describe the tilt of the camera (10) in relation to a reference plane in the space (2);
position data which describe the position of the camera (10) in relation to a reference point in the space (2).

11. The method according to claim 1, wherein a data processing device generates a data structure from the object position data determined for each object (P1-P6), which data structure indicates the three-dimensional position of each object (P1-P6) in the space (2).

12. A freely movable device (14), particularly a shopping trolley, glasses, a mobile phone or a tablet computer, for determining the position of at least one object (P1-P6) in a space (2), particularly of at least one product (P1-P6) positioned on a shelf (7), wherein this position is indicated by a light signal emitted by a light-emitting device (4A-4F) positioned adjacent to the object (P1-P6), which encodes identification information, with the help of which the object (P1-P6) can be identified,
wherein the device carries at least one camera (10) designed to generate a digital scene image of a scene captured by it,
and wherein the device, particularly the camera (10), is designed for the computerized determination of the position of the light signal appearing in the digital scene image relative to the camera (10) and the identification information emitted with the light signal,
and wherein the device, in particular the camera (10), is designed at least to support an automated determination of the orientation and position of the camera (10) in the space (2) when the scene is captured.

13. A light-emitting device (4A-4F), particularly a shelf label (4A-4F), which is designed to display product and/or price information, or a product separator designed to separate different products (P1-P6), wherein the light-emitting device (4A-4F) comprises:
a memory stage for storing identification information, with the help of which an object (P1-P6), particularly a product (P1-P6) positioned on a shelf (7), in the vicinity of which the light-emitting device (4A-4F) is positioned, can be identified, and
a light signal generation stage (6) designed to encode a light signal according to the identification information and to emit this encoded light signal.

14. A system (1) for determining the position of at least one object (P1-P6) in the space (2), particularly of at least one product (P1-P6) positioned on a shelf (7), wherein the system (1) comprises:
at least one light-emitting device, particularly a shelf label (4A-4F), which is designed to display product and/or price information, or a product separator designed to separate different products (P1-P6), wherein the light-emitting device (4A-4F) comprises:
a memory stage for storing identification information, with the help of which an object (P1-P6), particularly a product (P1-P6) positioned on a shelf (7), in the vicinity of which the light-emitting device (4A-4F) is positioned, can be identified, and
a light signal generation stage (6) designed to encode a light signal according to the identification information and to emit this encoded light signal; and
at least one freely movable device (14) according to claim 12.
